(19) United States
(12) Patent Application Publication
(10) Pub. No.: US 2013/0234590 A1
(43) Pub. Date: Sep. 12, 2013

(54) DISPLAY DEVICE AND METHOD FOR MANUFACTURING THE SAME

(71) Applicants: INNOCOM TECHNOLOGY(SHENZHEN)CO., LTD., Shenzhen City (CN); CHIMEI INNOLUX CORPORATION, Miao-Li County (TW)

(72) Inventors: Chun-Kai Li, Miao-Li County (TW); Hsin-Yuan Su, Miao-Li County (TW); Hsiang-Lun Hsu, Miao-Li County (TW)

(73) Assignees: CHIMEI INNOLUX CORPORATION, Miao-Li County (TW); INNOCOM TECHNOLOGY(SHENZHEN)CO., LTD., Shenzhen City (CN)

(21) Appl. No.: 13/691,895

(22) Filed: Dec. 3, 2012

(30) Foreign Application Priority Data
Mar. 8, 2012 (TW) 101107973

(51) Int. Cl. H05B 33/24; H05B 33/10

(52) U.S. Cl. CPC H05B 33/24; H05B 33/10
USPC 313/509; 445/24

(57) ABSTRACT

An display device comprising a plurality of pixel define units is disclosed. Each pixel define unit comprises patterned pixel define sections, a first electrode layer, an emission layer and a second electrode layer. The patterned pixel define section has a first lateral surface and a second lateral surface opposite to the first lateral surface. The first electrode layer comprises a first sub-electrode and a second sub-electrode. The first and second sub-electrodes are spaced apart from each other and respectively disposed on the first and second lateral surfaces. The emission layer is disposed on the first electrode layer. The second electrode layer is disposed on the emission layer.

This application claims the benefit of Taiwan application Serial No. 101107973, filed Mar. 8, 2012, the subject matter of which is incorporated herein by reference.

### BACKGROUND OF THE INVENTION

1. Field of the Invention

The invention is related to a display device and method for manufacturing the same, and more particularly to a display device having pixel define units and method for manufacturing the same.

2. Description of the Related Art

The light emitting mechanism of an organic light emitting diode (OLED) displayer is electroluminescent mechanism. Because the OLED displayer has lots of advantages such as wide viewing angle, short response time, high luminescence efficiency, low operating voltage, thin panel thickness, can be produced by simple manufacturing process and can be manufactured into large scale panel as well as flexible panel, OLED displayer has developed to be one of the mainstream displayers in market.

OLED displayer has a three-layer structure which includes a cathode electrode, an anode electrode and an organic material sandwiched between the cathode electrode and the anode electrode. When an electric field being applied to the cathode and the anode electrodes, electrons and electron holes flow into the organic materials respectively and incorporate with each other to form excitons. The exciton-forming process will radiate light during energy releasing procedure.

However, the mismatch of refractive index between the organic material layer and the two side layers adjacent to the organic material layer trend to induce waveguide effect. Therefore, some of the light generated by the organic material would be totally reflected at the boundaries between the organic material layer as well as the two side layers and incapable to emit light to outside, thereby reducing the luminous efficiency.

### SUMMARY OF THE INVENTION

The invention is directed to a display device having a plurality of pixel define units. By utilizing the specific first electrode layer of the pixel define units, light totally reflected in the emission layer and incapable to emit to outside can be reflected. Besides, the specific structure of the first electrode layer can be used to improve the contact area between the first electrode layer and the second electrode layer to improve the luminous efficiency.

According to a first aspect of the present invention, a display device comprising a first substrate, a second substrate opposite to the first substrate, a plurality of light emitting pixel units and a plurality of pixel define units disposed between the first substrate and the second substrate is disclosed. Each of the pixel define units comprises patterned pixel define sections, a first electrode layer, a emission layer and a second electrode layer. The patterned pixel define section has a first lateral surface and a second lateral surface opposite to the first lateral surface. The first electrode layer comprises a first sub-electrode and a second sub-electrode, the first sub-electrode is disposed on the first lateral surface and the second sub-electrode is disposed on the second lateral surface. The first sub-electrode and the second sub-electrode are spaced apart. The emission layer is disposed on the first electrode layer. The second electrode layer is disposed on the emission layer.

According to a second aspect of the present invention, a method for manufacturing a display device is disclosed. The method comprises following steps. A first substrate is provided. A plurality of patterned pixel define sections are formed on the first substrate. A first electrode layer is formed on the substrate and the patterned pixel define section. The first electrode layer comprises a first sub-electrode and a second sub-electrode. The first sub-electrode and the second sub-electrodes are spaced apart from each other. A emission layer is form on the first electrode layer. A second electrode layer is formed on the emission layer. A second substrate is provided and the second substrate is opposite to the first substrate.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A˜1H illustrate manufacturing processes of a cross section view of a display device according to one embodiment of the invention.

FIG. 2A illustrates a display device according to an embodiment of the invention.

FIG. 2B illustrates a display device according to another embodiment to the invention.

FIG. 3 illustrates a display device according to still another embodiment of the invention.

FIG. 4 illustrates a display device according to still another one embodiment of the invention.

FIG. 5 illustrates a display device according to still another one embodiment of the invention.

FIG. 6 illustrates a display device according to still another one embodiment of the invention.

FIG. 7 illustrates a display device according to still another one embodiment of the invention.

FIG. 8 illustrates a display device according to still another one embodiment of the invention.

### DETAILED DESCRIPTION OF THE INVENTION

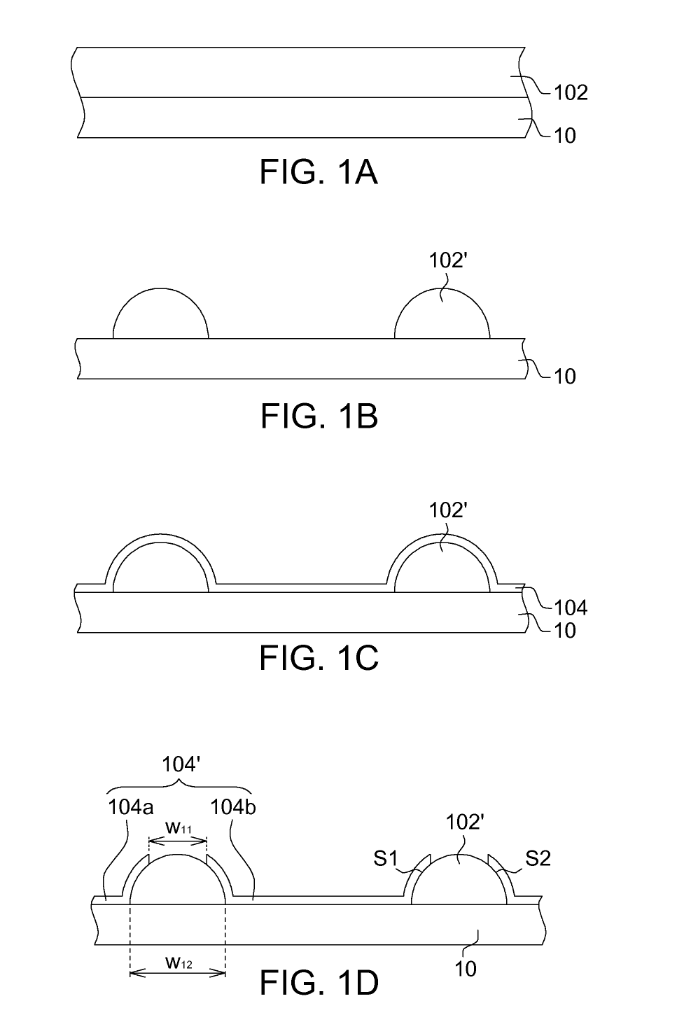

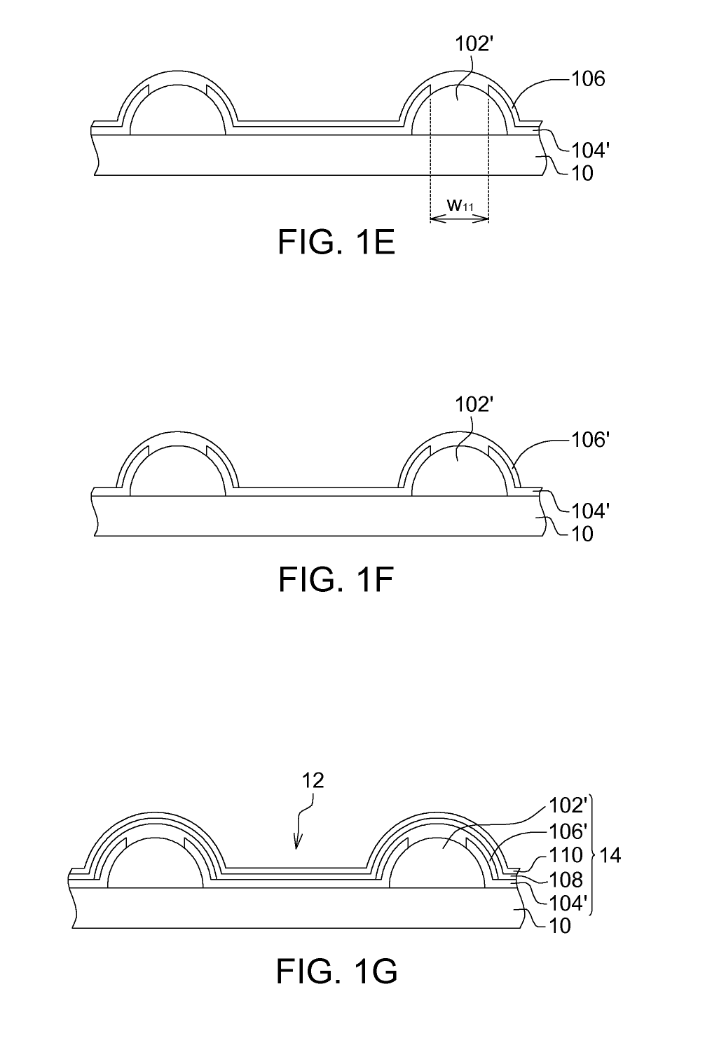

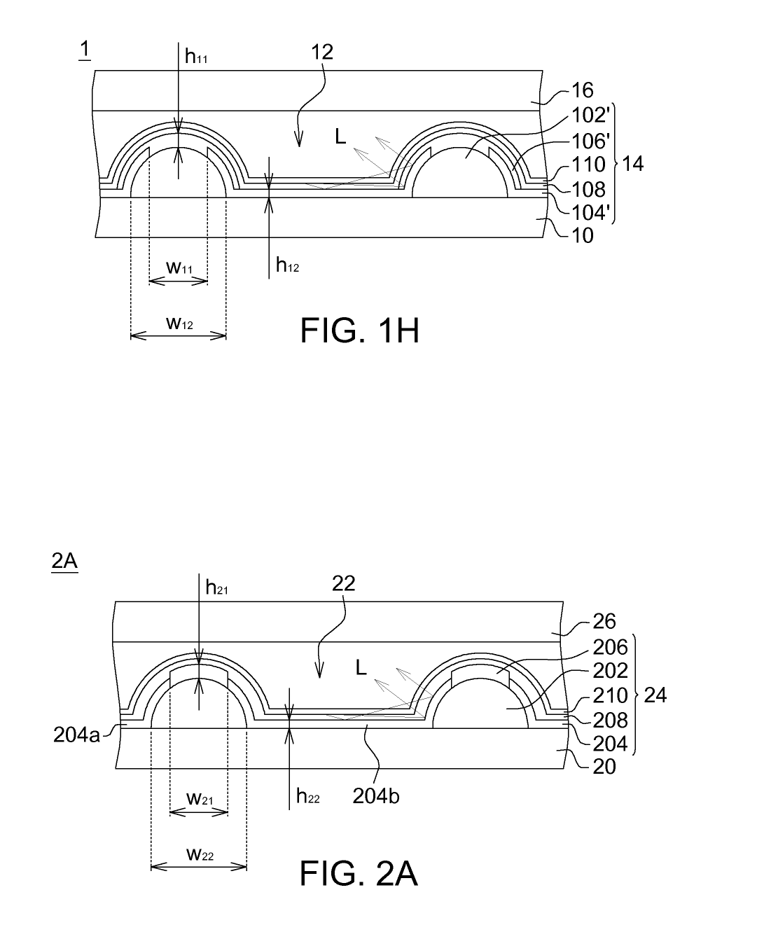

FIG. 1A˜1H illustrate manufacturing processes of display device 1 according to an embodiment of the invention. As shown in FIG. 1A, a first substrate 10 is provided. A pixel define layer 102 is formed on the first substrate 10. In FIG. 1B, pixel define layer 102 (shown in FIG. 1A) is patterned to form patterned pixel define sections 102′. In this embodiment, patterned pixel define sections 102′ are semi-cylindrical or semi-elliptical cylinder, and cross sections of the patterned pixel define sections 102′ are arc shapes.

As shown in FIG. 1C, an electrical conductive material 104 is formed on the first substrate 10 and the patterned pixel define sections 102′. As shown in FIG. 1D, the electrical conductive material 104 on the patterned pixel define sections 102′ (shown in FIG. 1C) is patterned to form the first electrode layer 104′. The first electrode layer 104′ comprises a first sub-electrode 104a and a second sub-electrode 104b spacing apart from the first sub-electrode 104a by a spacing w₁₁. The patterned pixel define sections 102′ has a first lateral surface S1 and a second lateral surface S2, the first sub-electrode 104a is disposed on the first lateral surface S1, the second sub-electrode 104b is disposed on the second lateral surface S2. The spacing w₁₁ is smaller than a maximum width w₁₂ of the patterned pixel define sections 102′.

As shown in FIG. 1E, an insulating material 106 is formed to cover the patterned pixel define sections 102′ exposed by the spacing w₁₁ and the first electrode layer 104′. As shown in FIG. 1F, the insulating material 106 (shown in FIG. 1E) is patterned to form the insulating layer 106′. As shown in FIG. 1G, the emission layer 108 is formed on the insulating layer 106′, and the second electrode layer 110 is formed on the emission layer 108. As shown in FIG. 1H, a second substrate 16 is provided. The second substrate 16 is opposite to the first substrate 10.

In this embodiment, the display device 1 comprises light emitting pixel unit 12 and pixel define units 14. In this embodiment, the display device 1 is for example an OLED display device, the light emitting pixel unit 12 is for example an OLED pixel unit, the pixel define units 14 are for example OLED pixel define units. The pixel define units 14 comprise patterned pixel define sections 102′, the first electrode layer 104′, the insulating layer 106′, the emission layer 108 and the second electrode layer 110. The first electrode layer 104′ is for example a reflect electrode layer, the second electrode layer is for example a transparent electrode layer. The insulating layer 106′ covers the patterned pixel define sections 102′ exposed by the spacing W₁₁ and parts of the first electrode layer 104′. The insulating layer 106′ is used for electrical insulating the first electrode layer 104′ and the second electrode layer 110. In particular, as long as the electrical insulation between the first electrode layer 104′ and the second electrode layer 110 can be achieved, there is no limitation to the shape of the insulating layer 106′. Besides, the height h₁₁ of the insulating layer 106′ is preferably larger than or equal to the height h₁₂ of the first electrode layer 104′.

In this embodiment, by disposing the first electrode layer 104′ on the opposite surfaces of the patterned pixel define sections 102′, problems of total reflection of light caused by a refractive index mismatch between the emission layer 108 and the electrode adjacent to the emission layer 108 can be solved. Therefore, the light L transmitted inside the emission layer 108 can be guided to the outside so that the luminous efficiency can be improved. In addition, the less the insulating layer 106′ covers the first electrode layer 104′, the larger the contact area between the first electrode layer 104′ and the emission layer 108 on the patterned pixel define section 102′. Therefore, the light emission area of the display device 1 can be improved.

In this embodiment, the first substrate 10 can be glass substrate or flexible substrate. Besides, the first substrate 10 can be transparent or non-transparent substrate. A color filter, such as a RGB or RGBW color filter can be disposed on the second substrate 16.

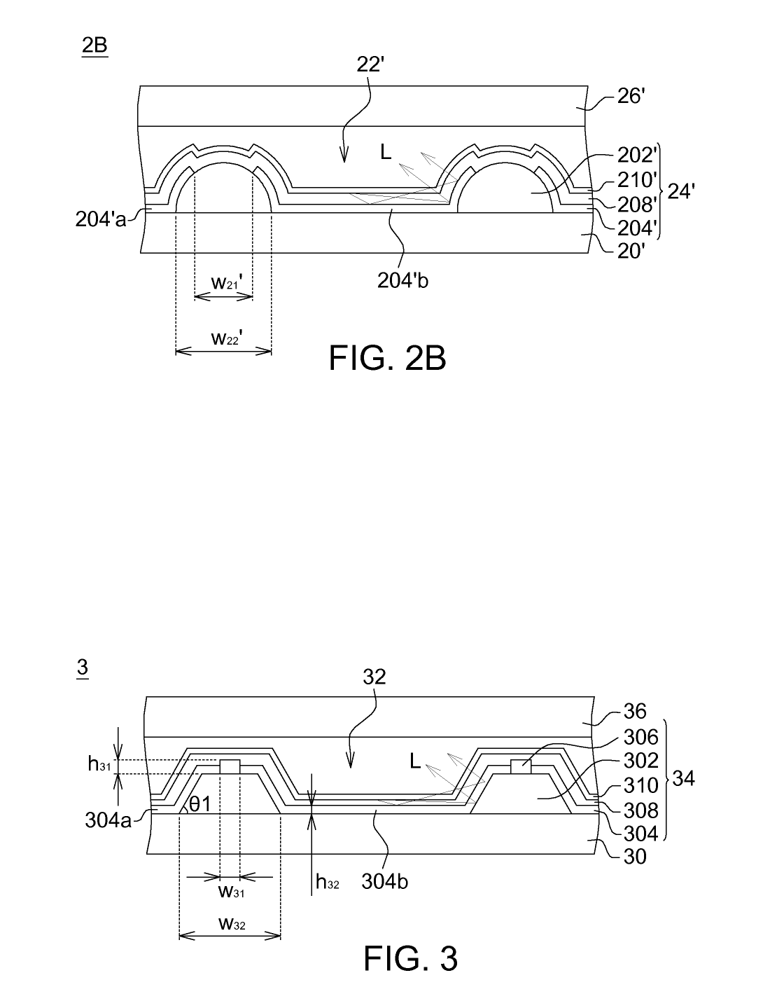

FIG. 2A illustrates a display device 2A according to another embodiment of the invention. As shown in FIG. 2A, the display device 2A comprises a first substrate 20, a second substrate 26, light emitting pixel units 22 and pixel define units 24. The light emitting pixel units 22 and pixel define units 24 are interlacedly arranged between the first substrate 20 and the second substrate 26. The structures and the manufacturing processes of the pixel define units 24 in FIG. 2A and that of the pixel define units in 14 FIG. 1H are similar. The pixel define units 24 comprises patterned pixel define sections 202, the first electrode layer 204, the insulating layer 206, the emission layer 208 and the second electrode layer 210. The first electrode layer 204 comprises a first sub-electrode 204a and a second sub-electrode 204b. The minimum distance between the first sub-electrode 204a and the second sub-electrode 204b is spacing w₂₁, and the spacing w₂₁ is smaller than the maximum width w₂₂ of the patterned pixel define section 202.

In particular, the insulating layer 206 in this embodiment covers at least the patterned pixel define section 202 exposed from the spacing w₂₁. Besides, the height h₂₁ of the insulating layer 206 is preferably larger than or equal to the height h₂₂ of the first electrode layer 204.

By disposing the first electrode layer 204 on the opposite surfaces of the patterned pixel define sections 202, problems of the total reflection of light caused by the refractive index mismatch between the emission layer 208 and the electrode layers adjacent to the emission layer 208 can be solved. Therefore, the light L transmitted inside the emission layer 208 is guided to the outside and the luminous efficiency can be improved. Moreover, since the insulating layer 206 covers merely the patterned pixel define section 202 exposed from the spacing w₂₁, contact areas between the first electrode layer 204 and emission layer 208 on the patterned pixel define sections 202 can be increased and light emitting area of the display device 2A can also be increased.

In this embodiment, the first substrate 20 can be glass substrate or flexible substrate. Besides, the first substrate 20 can be transparent or non-transparent substrate. The color filter, such as RGB color filter or RGBW color filter can be disposed on the second substrate 26.

FIG. 2B illustrates a display device 2B according to another one embodiment of the invention. As shown in FIG. 2B, the display device 2B comprises a first substrate 20′, a second substrate 26′, light emitting pixel units 22′ and pixel define units 24′. The light emitting pixel units 22′ and pixel define units 24′ are interlacedly arranged between the first substrate 20′ and the second substrate 26′.

In FIG. 2B, the pixel define unit 24′ comprise patterned pixel define sections 202′, a first electrode layer 204′, an emission layer 208′ and a second electrode layer 210′. The structure and manufacturing processes of the pixel define units 24′ are similar to that of the pixel define units 14 in FIG. 1H. The difference between the pixel define units 14 and the pixel define units 24′ is that the pixel define units 24′ lacks of the insulating layer. Therefore, the manufacturing process of the insulating layer can be omitted.

In this embodiment, the first substrate 20′ can be a glass substrate or a flexible substrate. The first substrate 20′ can be transparent or non-transparent. A color filter, such as a RGB or RGBW color filter can be disposed on the second substrate 26.

FIG. 3 illustrates a display device 3 according to another one embodiment of the invention. As shown in FIG. 3, the display device 3 comprises a first substrate 30, a second substrate 36, light emitting pixel units 32 and pixel define units 34. The light emitting pixel units 32 and pixel define units 34 are interlacedly arranged between the first substrate 30 and the second substrate 36. The pixel define units 34 in FIG. 3 comprises patterned pixel define sections 302, a first electrode layer 304, an insulating layer 306, an emission layer 308 and a second electrode layer 310. The structure and the manufacturing processes of the pixel define units 34 are similar to the pixel define units 14 in FIG. 1H, the differences between the pixel define units 14 and the pixel define units 34 are described below.

As shown in FIG. 3, a cross section of one of the patterned pixel define sections 302 is trapezoid shape and has a base angle θ₁. The base angle θ₁ ranges between 1 degree to 89 degrees. Preferably, the base angle θ₁ ranges between 30 degrees to 45 degrees. The first electrode layer 304 comprises a first sub-electrode 304a and a second sub-electrode 304b. A minimum distance between the first sub-electrode 304a and the second sub-electrode 304b is spacing w₃₁. The spacing w₃₁ is smaller than the maximum width w₃₂ of the patterned pixel define sections 302. The insulating layer 306 covers the patterned pixel define sections 302 exposed from the spacing w₃₁ to provide electrical insulation between the first electrode layer 304 and the second electrode layer 310. The insulating layer 306 corresponds to the spacing w₃₁ has a height h₃₁. Preferably, the height h₃₁ of the insulating layer 306 is larger than or equal to the height h₃₂ of the first electrode layer 304.

By disposing the first electrode layer 304 on the opposite surfaces of the patterned pixel define section 302, problems of the total reflection of light caused by the refractive index mismatch between the emission layer 308 and the electrode layers adjacent to the emission layer 308 can be solved. Therefore, the light L transmitted inside the emission layer 308 is guided to the outside so that the luminous efficiency can be improved. Moreover, since the insulating layer 306 merely covers the patterned pixel define section 302 exposed from the spacing w₂₁, contact areas between the first electrode layer 304 and emission layer 308 on the patterned pixel define section 302 can be increased and the light emitting area of the display device 3 can also be increased.

In this embodiment, the first substrate 30 can be a glass substrate or a flexible substrate. Besides, the first substrate 30 can be transparent or non-transparent. The color filter, such as RGB color filter or RGBW color filter can be disposed on the second substrate 36.

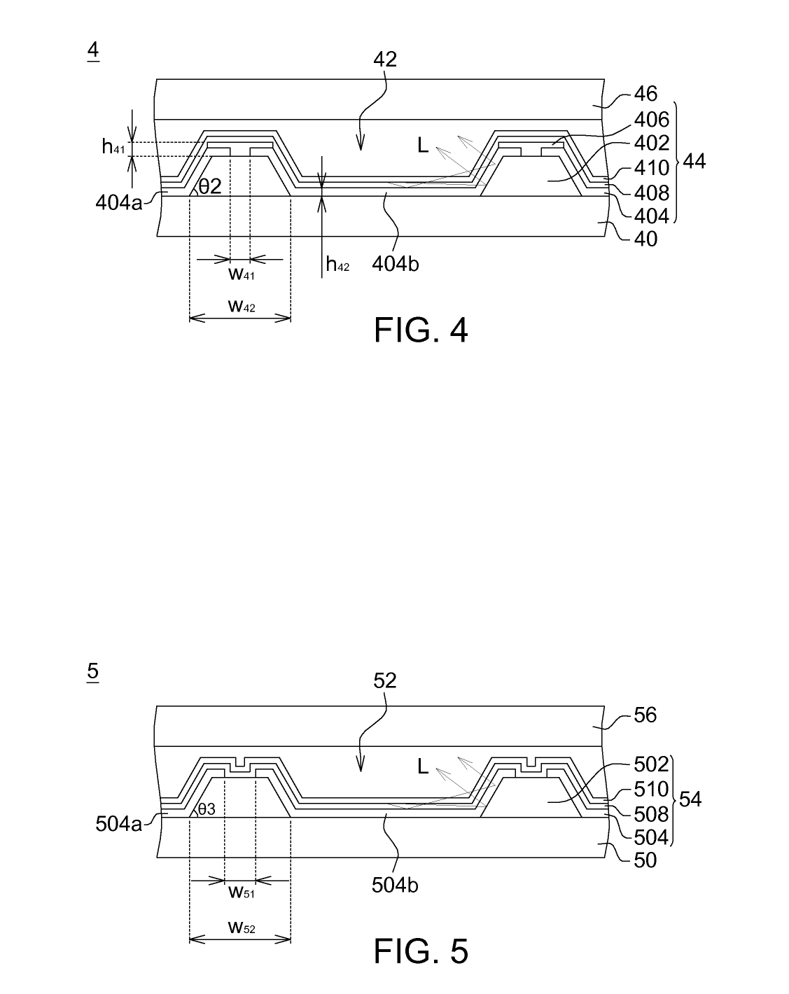

FIG. 4 illustrates a display device 4 according to another one embodiment of the invention. As shown in FIG. 4, the display device 4 comprises a first substrate 40, a second substrate 46, light emitting pixel units 42 and pixel define units 44. The light emitting pixel units 42 and pixel define units 44 are interlacedly arranged between the first substrate 40 and the second substrate 46.

The pixel define units 44 in FIG. 4 comprises patterned pixel define sections 402, a first electrode layer 404, an insulating layer 406, an emission layer 408 and a second electrode layer 410. The structure and the manufacturing processes of the pixel define units 44 are similar to that of the pixel define units 34 in FIG. 3. Differences between the pixel define units 44 and the pixel define units 34 are that the insulating layer 406 of the pixel define units 44 covers the not only the patterned pixel define section 402 exposed from the spacing w₄₁, but also covers a part of the first electrode layer 404. Therefore, the electrical insulation between the first electrode layer 404 and the second electrode layer 410 can be improved.

In this embodiment, the first electrode layer 404 comprises a first sub-electrode 404a and a second sub-electrode 404b, a minimum distance between the first sub-electrode 404a and the second sub-electrode 404b is the spacing w₄₁. The spacing w₄₁ is smaller than a width w₄₂ (maximum width of the patterned pixel define section 402). A height of the insulating layer 406 in the spacing w₄₁ is height h₄₁. Preferably, the height h₄₁ is larger than or equal to a height h₄₂ of the first electrode layer 404. A cross section of one of the patterned pixel define sections 402 is a trapezoid shape with a base angle θ₂. A range of the base angle θ₂ can be equal to the base angle θ₁ in FIG. 3.

In this embodiment, the total reflection of light caused by the refractive index mismatch between the emission layer 408 and electrodes adjacent to the emission layer 408 can be solved by disposing the first electrode layer 404 on opposite side surfaces of the patterned pixel define section 402, so as to guide the light L transmitting in the emission layer 408 to the outside. Therefore, the luminous efficiency can be increased. In addition, the less area the insulating layer 406 covers the first electrode layer 404, the more contact area between the first electrode layer 404 and the emission layer 408 on the patterned pixel define sections 402. Therefore, the luminous area of the display device 4 can be increased.

In this embodiment, the first substrate 40 can be a glass substrate or a flexible substrate. Besides, the first substrate 40 can be transparent or non-transparent. A color filter, such as a RGB or RGBW color filter can be disposed on the second substrate 46.

FIG. 5 illustrates a display device 5 according to another embodiment of the invention. As shown in FIG. 5, the display device 5 comprises a first substrate 50, a second substrate 56 and, light emitting pixel units 52 and pixel define units 54. The light emitting pixel units 52 and pixel define units 54 are interlacedly arranged between the first substrate 50 and the second substrate 56.

In FIG. 5, the pixel define units 54 comprises patterned pixel define sections 502, a first electrode layer 504, an emission layer 508 and the second electrode layer 510. The structure and the manufacturing process of the pixel define units 54 is similar to that of the pixel define units 34 in FIG. 3. The differences between the pixel define units 54 and the pixel define units 34 are that the pixel define units 54 requires no insulating layer. Therefore, the manufacturing process of the insulating layer can be omitted.

In this embodiment, a cross section of the patterned pixel define section 502 is trapezoid shaped and has a base angle θ₃. A range of the base angle θ₃ is the same as that of the base angle θ₁ in FIG. 3. The first electrode layer 504 comprises a first sub-electrode 504a and a second sub-electrode 504b. A minimum distance between the first sub-electrode 504a and the second sub-electrode 504b is spacing w₅₁. The spacing w₅₁ is smaller than a width w₅₂ of the patterned pixel define section 502. The width w₅₂ is a maximum width of the patterned pixel define section 502.

In this embodiment, the first substrate 50 can be glass substrate or flexible substrate. Besides, the first substrate 50 can be transparent or non-transparent substrate. A color filter, such as a RGB or RGBW color filter can be disposed on the second substrate 56.

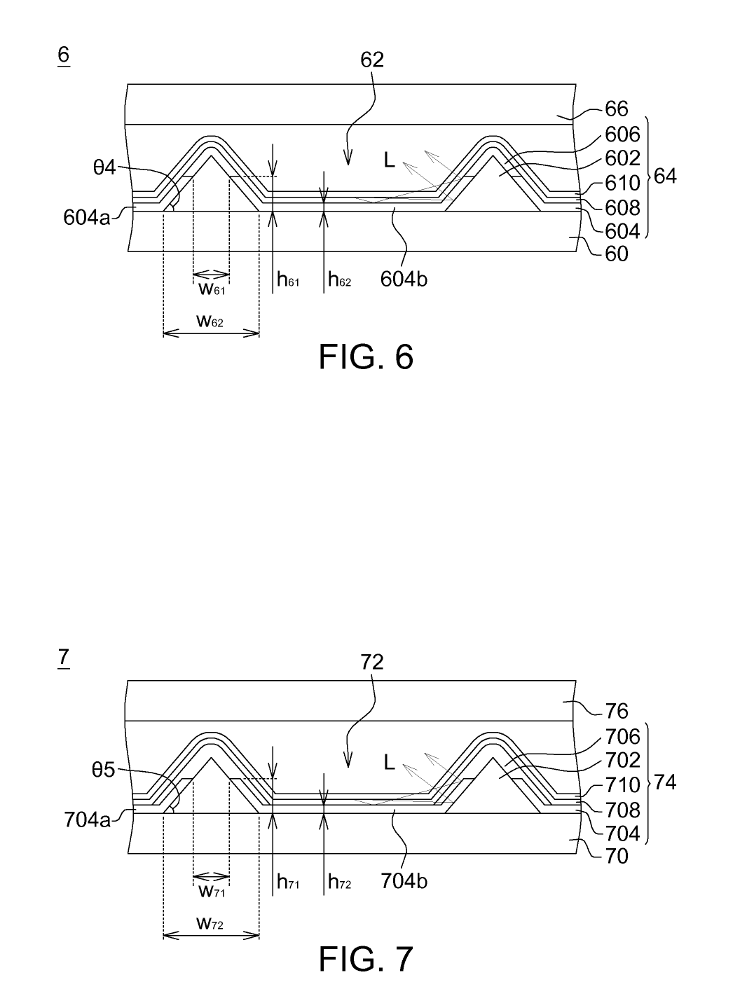

FIG. 6 illustrates a display device 6 according to another one embodiment of the invention. As shown in FIG. 6, the display device 6 comprises a first substrate 60, a second substrate 66, light emitting pixel units 62 and pixel define units 64. The light emitting pixel units 62 and pixel define units 64 are interlacedly arranged between the first substrate 60 and the second substrate 66. The pixel define units 64 in FIG. 6 comprises patterned pixel define sections 602, a first electrode layer 604, an insulating layer 606, an emission layer 608 and a second electrode layer 610. The structure and manufacturing processes of the pixel define units 64 are similar to that of the pixel define units 14 in FIG. 1H and are not described herein.

As shown in FIG. 6, a cross section of the patterned pixel define section 602 is triangle shaped and has a base angle θ₄. The base angle θ₄ ranges between 1 degree to 89 degrees. Preferably, the base angle θ₄ ranges between 30 degrees to 45 degrees. The first electrode layer 604 comprises the first sub-electrode 604a and the second sub-electrode 604b. A minimum distance between the first sub-electrode 604a and the second sub-electrode 604b is spacing w₆₁. The spacing w₆₁ is smaller than a width w₆₂ of the patterned pixel define section 602. The width w₆₂ is a maximum width of the patterned pixel define section 602. The insulating layer 606 covers the patterned pixel define section 602 exposed from the spacing w₆₁, and provides electrical insulation between the first electrode layer 604 and the second electrode layer 610. Besides, the first sub-electrode 604a or the second sub-electrode 604b are dispose on side surfaces of the patterned pixel define sections 602 with a vertical height h₆₁. Preferably, the vertical height h₆₁ is larger than a width h₆₂ of the first electrode layer 604.

By disposing the first electrode layer 604 on the opposite surfaces of the patterned pixel define section 602, problems of the total reflection of light caused by the refractive index mismatch between the emission layer 608 and the electrode layers adjacent to the emission layer 608 can be solved. Therefore, the light L transmitted inside the emission layer 608 is guided to the outside so that the luminous efficiency can be improved. Moreover, since the insulating layer 606 covers merely the patterned pixel define sections 602 exposed from the spacing w₆₁, contact areas between the first electrode layer 604 and emission layer 608 on the patterned pixel define section 602 can be increased and the light emitting area of the display device 6 can also be increased.

In this embodiment, the first substrate 60 can be glass substrate or flexible substrate. Besides, the first substrate 60 can be transparent or non-transparent substrate. A color filter, such as a RGB or RGBW color filter can be disposed on the second substrate 66.

FIG. 7 illustrates a display device 7 according to another embodiment of the invention. As shown in FIG. 7, the display device 7 comprises a first substrate 70, a second substrate 76, light emitting pixel units 72 and pixel define units 74. The light emitting pixel units 72 and pixel define units 74 are interlacedly arranged between the first substrate 70 and the second substrate 76.

The pixel define units 74 in FIG. 7 comprises patterned pixel define sections 702, a first electrode layer 704, an insulating layer 706, an emission layer 708 and a second electrode layer 710. The structures and the manufacturing processes of the pixel define units 74 are similar to that of the pixel define units 64 in FIG. 6. The differences between the pixel define units 74 and the pixel define units 64 are that the insulating layer 706 of the pixel define units 74 covers not only the patterned pixel define section 702 exposed from the spacing w₇₁, but also a part of the first electrode layer 704. Therefore, the electrical insulation between the first electrode layer 704 and the second electrode layer 710 can be improved.

In this embodiment, the triangle shaped patterned pixel define section 702 has a base angle θ₅. A range of the base angle θ₅ is the same as the base angle θ₄ in FIG. 6. The first electrode layer 704 comprises a first sub-electrode 704a and a second sub-electrode 704b. The minimum distance between the first sub-electrode 704a and the second sub-electrode 704b is a width of the spacing w₇₁. The width of the spacing w₇₁ is smaller than the maximum width w₇₂ of the patterned pixel define section 702. Besides, the first sub-electrode 704a or the second sub-electrode 704b are disposed on opposite side surfaces of the patterned pixel define sections 702 with a vertical height h₇₁. Preferably, the vertical height h₇₁ is larger than a width h₇₂ of the first electrode layer 704.

In this embodiment, by disposing the first electrode layer 704 on the opposite surfaces of the patterned pixel define sections 702, problems of the total reflection of light caused by the refractive index mismatch between the emission layer 708 and the electrode layers adjacent to the emission layer 708 can be improved. Therefore, the light L transmitted inside the emission layer 708 is guided to the outside and the luminous efficiency can be improved. Moreover, since the insulating layer 706 covers merely the patterned pixel define sections 702 exposed from the spacing w₇₁, contact areas between the first electrode layer 704 and emission layer 708 on the patterned pixel define sections 702 can be increased and the light emitting area of the display device 7 can also be increased.

In this embodiment, the first substrate 70 can be glass substrate or flexible substrate. Besides, the first substrate 70 can be transparent or non-transparent substrate. A color filter, such as a RGB or RGBW color filter can be disposed on the second substrate 76.

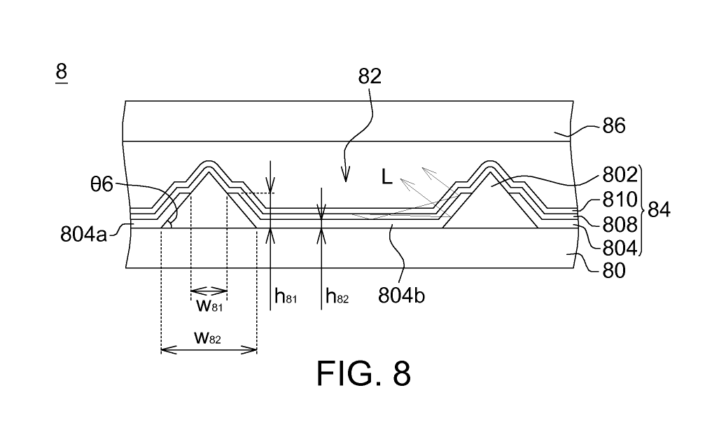

FIG. 8 illustrates a display device 8 according to another embodiment of the invention. As shown in FIG. 8, the display device 8 comprises a first substrate 80, a second substrate 86, light emitting pixel units 82 and pixel define units 84. The light emitting pixel units 82 and pixel define units 84 are interlacedly arranged between the first substrate 80 and the second substrate 86.

In FIG. 8, the pixel define units 84 comprises patterned pixel define sections 802, a first electrode layer 804, an emission layer 808 and a second electrode layer 810. The structures and the manufacturing processes of pixel define units 84 are similar to that of the pixel define units 64 in FIG. 6. The differences between the pixel define units 84 and the pixel define units 64 are that the pixel define units 84 require no an insulating layer, so that the manufacturing process of an insulating layer can be omitted.

In this embodiment, the triangle shaped patterned pixel define section 802 has a base angle θ₆. A range of base angle θ₆ can be the same as the range of the base angle θ₄ in FIG. 6. The first electrode layer 804 comprises a first sub-electrode 804a and a second sub-electrode 804b. The minimum distance between the first sub-electrode 804a and the second sub-electrode 804b is a width of the spacing w₈₁, the width of the spacing w₈₁ is smaller than the maximum width w₈₂ of the patterned pixel define section 802. Besides, the first sub-electrode 804a or the second sub-electrode 804b are dispose on opposite side surfaces of the patterned pixel define sections 802 with a vertical height h₈₁. Preferably, the vertical height h₈₁ is larger than a width h₈₂ of the first electrode layer 804.

In this embodiment, the first substrate 80 can be glass substrate or flexible substrate. Besides, the first substrate 80 can be transparent or non-transparent substrate. A color filter, such as a RGB or RGBW color filter can be disposed on the second substrate 86.

Based on the above, a display device according to the embodiments described above can be manufactured by uncomplicated manufacturing processes. By disposing an electrode layer on opposite side surfaces of patterned pixel define sections of the display device, the total reflection of light caused by a refractive index mismatch between the emission layer and the electrode adjacent to the emission layer can be destroyed. Therefore, the light transmitted inside the emission layer can be guided to the outside so that the luminous efficiency of the display device can be improved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a plurality of pixel define units, each of the pixel define units comprising:
a patterned pixel define section having a first lateral surface and a second lateral surface opposite to the first lateral surface;
a first electrode layer, comprising a first sub-electrode and a second sub-electrode, the first sub-electrode disposed on the first lateral surface and the second sub-electrode disposed on the second lateral surface, and the first sub-electrode and the second sub-electrode being spaced apart;
an emission layer disposed on the first electrode layer; and
a second electrode layer disposed on the emission layer.

2. The display device according to claim 1, wherein the first electrode layer is a reflective electrode layer.

3. The display device according to claim 1, wherein the spacing is smaller than a maximum width of a cross section of the patterned pixel define section.

4. The display device according to claim 1, further comprising an insulating layer, disposed between the patterned pixel define section and the emission layer.

5. The display device according to claim 4, wherein the insulating layer covers the patterned pixel define section exposed from the spacing, and a thickness of the insulating layer is larger than a thickness of the first electrode layer.

6. The display device according to claim 4, wherein the insulating layer covers the patterned pixel define section exposed from the spacing and a part of the first electrode layer.

7. The display device according to claim 1, wherein the patterned pixel define section is a semi-cylinder or a semi-elliptic cylinder, the first lateral surface and the second lateral surface are cylindrical surfaces.

8. The display device according to claim 1, wherein a cross section of the patterned pixel define section is a trapezoid shape, the trapezoid shape has a base angle, the base angle is between 30 degrees to 45 degrees.

9. The display device according to claim 1, wherein a cross section of the patterned pixel define section is a triangle shape, the triangle shape has another base angle, the another base angle is between 30 degrees to 45 degrees.

10. The display device according to claim 1, further comprising:
a first substrate;
a second substrate, opposite to the first substrate; and
a plurality of light emitting pixel unit, disposed between the first substrate and the second substrate,
wherein the pixel define units disposed between the first substrate and the second substrate, each of the light emitting pixel units and each of the pixel define units are spaced apart from each other.

11. The display device according to claim 10, further comprising a color filter disposed on the second substrate.

12. The display device according to claim 10, wherein the light emitting pixel units are organic light emitting diode pixel units, the pixel define units are organic light emitting diode pixel define units.

13. A method for manufacturing a display device, comprising:
providing a first substrate;
forming a plurality of patterned pixel define sections on the first substrate;
forming a first electrode layer on the first substrate and the patterned pixel define sections, the first electrode layer comprising a first sub-electrode and a second sub-electrode, and the first sub-electrode and the second sub-electrodes spaced apart from each other by a spacing;
forming an emission layer on the first electrode layer;
forming a second electrode layer on the emission layer; and
providing a second substrate opposite to the first substrate.

14. The method for manufacturing a display device according to claim 13, wherein before forming the emission layer further comprises:
forming an insulating layer to cover the patterned pixel define sections exposed from the spacing, and a thickness of the insulating layer is larger than a thickness of the first electrode layer.

15. The method for manufacturing a display device according to claim 13, wherein before forming the emission layer further comprises:
forming an insulating layer to cover the patterned pixel define sections exposed from the spacing and a part of the first electrode layer.

16. The method for manufacturing a display device according to claim 13, wherein forming the patterned pixel define sections comprises:
forming a pixel define layer on the first substrate; and
patterning the pixel define layer to form the patterned pixel define sections, a cross section of each of the patterned pixel define sections is one of an arc shape, a trapezoid shape and a triangle shape.

17. The method for manufacturing a display device according to claim 13, wherein each of the patterned pixel define sections has a first lateral surface and a second lateral surface opposite to the first lateral surface, a step of forming the first electrode layer comprises:
forming an electrical conductive material on the first substrate and the patterned pixel define sections; and
patterning the electrical conductive material on each of the patterned pixel define sections to form the first sub-electrode and the second sub-electrode, the first sub-electrode and the second sub-electrode are spaced apart from each other by the spacing, the first sub-electrode is disposed on the first lateral surface and the second sub-electrode is disposed on the second lateral surface.
